(19) United States
(12) Patent Application Publication
(10) Pub. No.: US 2025/0178303 A1
(43) Pub. Date: Jun. 5, 2025

(54) METHOD FOR PRODUCING SELF-STANDING PACKAGING BAG, SEALING MEMBER USED TO PRODUCE THE SELF-STANDING PACKAGING BAG, AND SELF-STANDING PACKAGING BAG PRODUCED BY THE METHOD FOR PRODUCING SELF-STANDING PACKAGING BAG

(71) Applicant: HOSOKAWA YOKO CO., LTD., Tokyo (JP)

(72) Inventors: Akio YOUTOU, Tokyo (JP); Yohei KAGEYAMA, Tokyo (JP); Takuro MARUYAMA, Tokyo (JP); Yoshihiro TAKEUCHI, Tokyo (JP)

(21) Appl. No.: 18/962,003

(22) Filed: Nov. 27, 2024

(30) Foreign Application Priority Data
Nov. 30, 2023 (JP) 2023-202309
Sep. 25, 2024 (JP) 2024-166385

(51) Int. Cl. B31B 70/64; B32B 27/32; B65D 75/00

(52) U.S. Cl. CPC B31B 70/64; B65D 75/008; B31B 2150/002

(57) ABSTRACT

A method for producing a self-standing packaging bag includes a pair of flat portions and a bottom portion folded in half into an inverted V shape and disposed in a lower part of the pair of flat portions, that has side seal portions and bottom seal portions, and that has step portions formed due to overlapping of films between two-layer portions in which the pair of flat portions overlap each other and four-layer portions in which the pair of flat portions overlap the bottom portion, the method including: forming bottom seal portions in which regions including at least parts of the step portions are unsealed portions in a first sealing step including heating, pressurizing, and cooling; and sealing the unsealed portions in second and subsequent sealing steps. A sealing member used for the production method, and a self-standing packaging bag are produced by the production method.

### TECHNICAL FIELD

The present invention relates to a method for producing a self-standing packaging bag, a sealing member used to produce the self-standing packaging bag, and a self-standing packaging bag produced by the method for producing a self-standing packaging bag.

### BACKGROUND ART

Many packaging bags formed from film materials such as synthetic resins are known.

In one known laminate forming such packaging bags, a sealing layer formed of a heat-fusible synthetic resin is provided as the innermost layer. When this laminate is used to form a pouched packaging bag, desired regions are heated and pressurized for heat sealing to form seal portions.

One previously known self-standing packaging bag SPB-C, which is a packaging bag capable of standing on its own, is shown in FIG. 12. The conventional self-standing packaging bag SPB-C shown in FIG. 12 includes a pair of flat portions 11 and a bottom portion 12 disposed in a lower part of the pair of flat portions 11 and folded in half into an inverted V shape. The packaging bag is produced by forming conventional bottom seal portions 21C and side seal portions 22 on opposite sides of the flat portions.

The conventional self-standing packaging bag SPB-C has the side seal portions 22 on opposite sides of the flat portions 11. The conventional self-standing packaging bag SPB-C has, in its lower part, the conventional bottom seal portions 21C formed into a boat shape. The flat portions 11 and the bottom portion 12 are bonded together at the side seal portions 22 and the conventional bottom seal portions 21C.

The conventional self-standing packaging bag SPB-C shown in FIG. 12 can be obtained by disposing a bottom portion-forming film 12 folded in half into an inverted V shape in a lower part of a pair of flat portion-forming films 11 as shown in FIG. 13 (a), holding the bottom portion-forming film 12 between lower parts of the two flat portion-forming films 11 as shown in FIG. 13 (b), then first forming the conventional bottom seal portions 21C as shown in FIG. 13 (c), and forming the side seal portions 22 on opposite sides as shown in FIG. 13 (d). In this case, cut-out portions 13 are provided on opposite sides of the bottom portion-forming film 12 folded in half into the inverted V shape. In the side seal portions 22, the innermost fusible layers of the pair of flat portions 11 are sealed together through the cut-out portions 13.

These seal portions are each formed by heating and pressurization followed by cooling using a set of sealing jigs. When all the seals in the packaging bag are formed by continuous heating and pressurization without cooling after the heating and pressurization, portions not intended to be sealed are also heat-sealed by residual heat. It is therefore necessary to perform cooling after the heating and pressurization.

The conventional self-standing packaging bag SPB-C shown in FIG. 12 includes: two-layer portions TL each including the pair of flat portion-forming films 11 forming the flat portions 11 of the self-standing packaging bag; and four-layer portions FL each including the pair of flat portion-forming films 11 and the bottom portion-forming film 12 folded in half into a two-ply form, and the boundaries between the two-layer portions TL and the four-layer portions FL are step portions formed due to the overlapping of the films. The step portions include first step portions 31 each originating from a bottom portion-forming film fold line 14 and second step portions 32 originating from the respective cut-out portions 13 formed in the bottom portion-forming film 12. FIG. 14 is a cross-sectional view of a first step portion 31 formed at the boundary between a two-layer portion TL and a four-layer portion FL in the conventional self-standing packaging bag SPB-C.

As shown in FIG. 12, the side seal portions 22 and the conventional bottom seal portions 21C are seal portions extending across the first step portions 31 and the second step portions 32. In particular, in the first step portions 31, the conventional bottom seal portions 21C seal the entire regions of the step portions that overlap the side seal portions 22. However, the difference in thickness at the step portions causes a difference in pressure from the sealing bars, and the seals near the step portions on the two-layer portion TL side may be insufficient, resulting in insufficient adhesion. In this case, it is feared that the contents may leak from the insufficiently seal portions. In particular, the conventional bottom seal portions 21C are used to seal mainly the four-layer portions FL. Therefore, the pressure applied near the step portions, more specially on the two-layer portion TL side in the first step portions 31 formed at the boundaries between the four-layer portions FL and the two-layer portions TL shown in FIG. 14, tends to be insufficient, and the sealing tends to be insufficient. 26 in FIG. 12 represents unsealed portions in the conventional bottom seal portions 21C. The unsealed portions are provided to prevent wrinkles that can occur when the entire conventional bottom seal portions 21C are sealed and are conventional unsealed bottom portions 26.

To solve the foregoing problems, various proposals have been made.

PTL 1 discloses a packaging bag production method including: a laminating step of forming a laminate including a pair of side sheets and a bottom sheet folded in half and held between the side sheets; and a bonding step of bonding the side sheets and the bottom sheet of the laminate together. The bonding step includes: a first bonding step of heating and pressurizing four-layer portions of the laminate in which the bottom sheet is located to thereby bond lower bonding portions; a second bonding step of heating and pressurizing two-layer portions of the laminate in which the bottom sheet is not present to thereby bond side bonding portions; and a third bonding step of heating and pressurizing boundary portions between the two-layer portions of the laminate in which the bottom sheet is not present and the four-layer portions in which the bottom sheet is present to thereby bond the boundary portions with the lower bonding portions in the side bonding portions. An object of PTL 1 is to provide a method for producing a packaging bag in which liquid leakage is suppressed.

In PTL 1, when synthetic resin films forming the innermost heat-sealable layers are formed of a resin having a melting point, even if cooling is performed after the heating and pressurization in each sealing step, the resin melts each time the resin is heated to higher than or equal to the melting point. Therefore, by repeating the sealing operation intensively many times, strong seals can be ensured. Polyethylene films frequently used for packaging bags and packaging bags formed from polypropylene films are based on the above sealing mechanism.

Some packaging bags are used to contain pharmaceuticals and quasi drugs containing active ingredients such as fomentations in their contents and foods and cosmetics containing perfumes and spices in their contents. There is a strong demand for these packaging bags to reduce the amount of the perfumes, spices, or active ingredients in the contents adsorbing to the bags in order to maintain the amounts of the perfumes, spices, or active ingredients in the contents at the desired levels.

Therefore, in some cases, packaging bags are formed using a laminate using a highly non-adsorptive resin in the innermost heat-sealable layer. PTL 2 disclose, as a non-adsorptive film used as a heat-sealable layer, a layer formed of an amorphous polyester copolymer having a glass transition point of 70 to 90° C. It is stated that both good non-adsorptivity and good sealing strength can be achieved with the disclosed film and the film can be easily formed.

A packaging bag in which a highly amorphous polyester-based resin is used as the film forming the heat-sealable layer can be sealed by heating the film to a temperature higher than or equal to the melting point of the resin. However, the melting point of the polyester-based resin is very high, i.e., about 250° C. Therefore, if the film is heated to a temperature higher than or equal to the melting point of the polyester-based resin, an adjacent layer also melts. In this case, it is difficult to produce packaging bags stably, and it is feared that problems may occur in the produced packaging bags.

One method to address the above issue is to set the heating temperature in the sealing step to a temperature lower than the melting point of the highly amorphous polyester-based resin to soften the resin for bonding.

When this method is used to produce a self-standing packaging bag, if cooling is performed after the heating and pressurization in the step of sealing the step portions, the crystallization of the amorphous portions of the polyester-based resin proceeds. In this case, even when the heating is again performed in the next sealing step, the crystallized molecules do not return to the amorphous state, and high crystallinity is maintained. Therefore, when the bonding in the initial sealing step including heating, pressurization, and cooling was insufficient, the degree of crystallinity of the polyester molecules increases as the number of repetitions of sealing by heating and pressurization increases while the bonding remains insufficient, and the bonding may be insufficient. Therefore, with the production method described in PTL 1, strong seals may not be obtained.

Accordingly, PTL 3 discloses a sealing method used when a self-standing packaging bag is produced using laminates each including a heat-sealable layer using an amorphous polyester. The packaging bag sealing method includes: a first step of disposing the laminates such that the heat-sealable layers face each other in a step portion in which bonding can be insufficient and forming a seal to thereby bond the heat-sealable layers together; and a second step of fusing a step portion formed by further overlapping the two laminates joined together in the first step using a sealing method, such as an ultrasonic sealing method or a high-frequency dielectric sealing method, that uses a larger amount of heat than that in the first step.

### CITATION LIST

### Patent Literature

[PTL 1] Japanese Unexamined Patent Application Publication No. 2021-183390
[PTL 2] Japanese Unexamined Patent Application Publication No. 2015-66802
[PTL 3] Japanese Unexamined Patent Application Publication No. 2017-217764

### SUMMARY OF INVENTION

### Technical Problem

However, in the packaging bag production method in PTL 3, it is necessary to provide an ultrasonic sealing mechanism or a high-frequency dielectric sealing mechanism separately in addition to the heat sealing mechanism. Therefore, the structure of the bag making machine is complicated, and this is disadvantageous in terms of cost, maintenance, etc. Moreover, when ultrasonic sealing or high-frequency dielectric sealing is performed in addition to the heat sealing, the sealed portions of the laminates are extremely reduced in thickness, and their strength decreases. In addition, the resin in the heat-sealable layers in the thinned portions melts and flows into the content-containing portion, and resin lumps are formed in some cases. Visually noticeable ultrasonic sealing marks or high-frequency dielectric sealing marks remain in the packaging bag, and this spoils the appearance of the packaging bag.

An object to be achieved by the present invention is to provide a method for producing a self-standing packaging bag having step portions formed due to overlapping of films. With the method for producing a self-standing packaging bag, regions around the step portions can be reliably and sufficiently sealed, and the step portions can have a good appearance. Moreover, the occurrence of leakage of the contents can be prevented. Other objects of the invention are to provide a sealing member used to produce the self-standing packaging bag and the self-standing packaging bag produced using the self-standing packaging bag production method.

### Solution to Problem

The present inventors have conducted extensive studies in order to solve the foregoing problems and found that the problems can be solved by a specific method for producing a self-standing packaging bag, a sealing member used to produce the self-standing packaging bag, and a self-standing packaging bag produced by the self-standing packaging bag production method. Thus, the invention has been completed.

Accordingly, the present invention provides the following method for producing a packaging bag, a sealing member used to produce the packaging bag, and a packaging bag produced by the method for producing a packaging bag.

### [Item 1]

A method for producing a self-standing packaging bag that includes a pair of flat portions and a bottom portion folded in half into an inverted V shape and disposed in a lower part of the pair of flat portions, that has side seal portions and bottom seal portions, and that has step portions formed due to overlapping of films between two-layer portions in which the pair of flat portions overlap each other and four-layer portions in which the pair of flat portions overlap the bottom portion,
the method including: in a first sealing step, performing heating and pressurization such that regions including at least parts of the step portions remain as unsealed portions and then performing cooling to form the bottom seal portions; and sealing the unsealed portions by heating, pressurization, and cooling in second and subsequent sealing steps.

### [Item 2]

The method for producing a self-standing packaging bag according to Item 1, wherein the pair of flat portions and the bottom portion are each formed of a film including a heat-sealable layer containing a polyester-based resin.

### [Item 3]

A sealing member used for a method for producing a self-standing packaging bag that includes a pair of flat portions and a bottom portion folded in half into an inverted V shape and disposed in a lower part of the pair of flat portions, that has side seal portions and bottom seal portions, and that has step portions formed due to overlapping of films between two-layer portions in which the pair of flat portions overlap each other and four-layer portions in which the pair of flat portions overlap the bottom portion,
wherein the sealing member is a heat sealing die used in a first sealing step to form the bottom seal portions such that regions including at least parts of the step portions remain as unsealed portions.

### [Item 4]

A self-standing packaging bag produced by the method for producing a self-standing packaging bag according to Item 1 or 2.

### [Item 5]

A method for producing a self-standing packaging bag that includes a pair of flat portions and a bottom portion folded in half into an inverted V shape and disposed in a lower part of the pair of flat portions, that has side seal portions and bottom seal portions, and that has step portions formed due to overlapping of films between two-layer portions in which the pair of flat portions overlap each other and four-layer portions in which the pair of flat portions overlap the bottom portion,
wherein the method uses a bag making machine including a plurality of sets of sealing jigs that are used for heating and pressurization and then for cooling, and
wherein the step portions include regions that are sealed only by a last set of sealing jigs.

### Advantageous Effects of Invention

The present invention provides the method for producing the self-standing packaging bag including the step portions formed due to the overlapping of the films. Even when the heat-sealable layer included in each of the films used is formed of a highly amorphous polyester-based resin, the step portions can be reliably sealed. The seals in the step portions have a good appearance, and the occurrence of leakage of the liquid contents is prevented. The invention also provides the sealing member used for the method for producing a self-standing packaging bag and a self-standing packaging bag produced by the self-standing packaging bag production method.

### BRIEF DESCRIPTION OF DRAWINGS

FIG. 1 A schematic illustration of a self-standing packaging bag obtained by the method for producing a self-standing packaging bag according to the invention.

FIG. 2 A schematic illustration showing an embodiment of a step included when self-standing packaging bags are produced using the self-standing packaging bag production method according to the invention.

FIG. 3 A schematic illustration showing an embodiment of a bottom portion-forming film used when the self-standing packaging bags are produced by the self-standing packaging bag production method according to the invention.

FIG. 4 Cross-sectional views showing an embodiment when a pair of flat portion-forming films and bottom portion-forming films are disposed so as to overlap each other when the self-standing packaging bags are produced by the self-standing packaging bag production method according to the invention.

FIG. 5 A schematic illustration showing an embodiment of a step included when the self-standing packaging bags are produced by the self-standing packaging bag production method according to the invention.

FIG. 6 A schematic illustration showing an embodiment of a bottom portion-forming sealing member used when the self-standing packaging bags are produced by the self-standing packaging bag production method according to the invention.

FIG. 7 Schematic illustrations showing an embodiment of a step included when the self-standing packaging bags are produced using the self-standing packaging bag production method according to the invention.

FIG. 8 Schematic illustrations showing an embodiment of a step included when the self-standing packaging bags are produced using the self-standing packaging bag production method according to the invention.

FIG. 9 A schematic illustration showing an embodiment of the bottom portion-forming sealing member used when the self-standing packaging bags in the invention are produced.

FIG. 10 A schematic illustration showing an embodiment of a bottom portion-forming sealing member used when self-standing packaging bags in a related art are produced.

FIG. 11 A schematic illustration showing an embodiment of a sealing member used when the self-standing packaging bags in the invention are produced.

FIG. 12 A schematic illustration of a self-standing packaging bag in a related art.

FIG. 13 Schematic illustrations showing a process of producing the self-standing packaging bag in the related art.

FIG. 14 A cross-sectional view of a step portion formed at the boundary between a two-layer portion and a four-layer portion in a self-standing packaging bag.

### DESCRIPTION OF EMBODIMENTS

The method for producing a self-standing packaging bag according to the invention, a sealing member used for the method for producing a self-standing packaging bag, and a self-standing packaging bag produced by the method for producing a self-standing packaging bag will be described in detail.

### [Method for Producing Self-Standing Packaging Bag]

A self-standing packaging bag production method according to the invention is a method for producing a self-standing packaging bag that includes a pair of flat portions and a bottom portion folded in half into an inverted V shape and disposed in a lower part of the pair of flat portions, that has side seal portions and bottom seal portions, and that has step portions formed due to overlapping of films between two-layer portions in which the pair of flat portions overlap each other and four-layer portions in which the pair of flat portions overlap the bottom portion. The method includes: in a first sealing step, performing heating and pressurization such that regions including at least part of the step portions remain as unsealed portions and then performing cooling to form the bottom seal portions; and sealing the unsealed portions by heating, pressurization, and cooling in second and subsequent sealing steps.

A self-standing packaging bag production method according to the invention is a method for producing a self-standing packaging bag that includes a pair of flat portions and a bottom portion folded in half into an inverted V shape and disposed in a lower part of the pair of flat portions, that has side seal portions and bottom seal portions, and that has step portions formed due to overlapping of films between two-layer portions in which the pair of flat portions overlap each other and four-layer portions in which the pair of flat portions overlap the bottom portion. The method uses a bag making machine including a plurality of sets of sealing jigs that are used for heating and pressurization and then for cooling, and the step portions include regions that are sealed only by the last set of sealing jigs.

No particular limitation is imposed on the self-standing packaging bag produced by the self-standing packaging bag production method according to the invention so long as the self-standing packaging bag has the step portions formed due to the overlapping of the films. The self-standing packaging bag may have, for example, a zipper or a spout.

### <Self-Standing Packaging Bag>

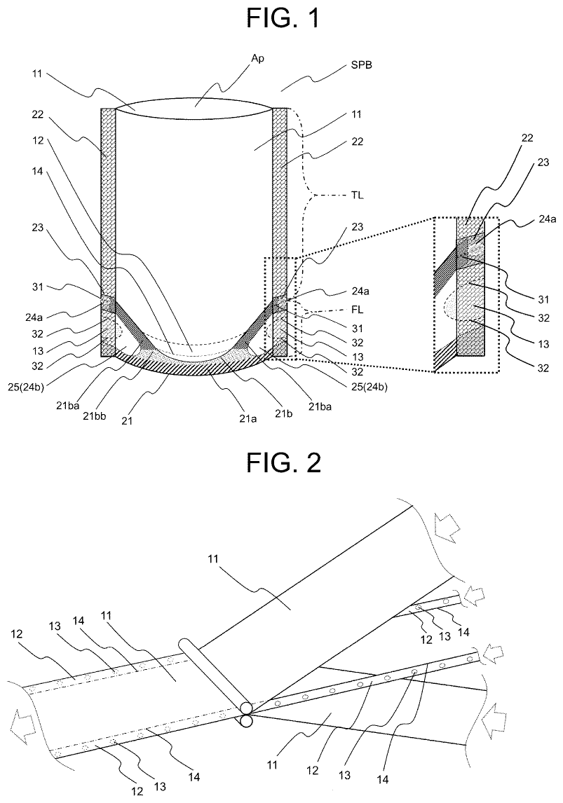

FIG. 1 is a schematic illustration of a self-standing packaging bag SPB produced by a self-standing packaging bag production method according to an embodiment of the invention. In the self-standing packaging bag SPB in the present embodiment, a pair of flat portions 11, a bottom portion 12 having cut-out portions 13, side seal portions 22, two-layer portions TL, four-layer portions FL, first step portions 31, and second step portions 32 are the same as those in the conventional self-standing packaging bag SPB-C and will be described using the same symbols.

The self-standing packaging bag SPB shown in FIG. 1 includes the pair of flat portions 11 and the bottom portion 12 folded in half into an inverted V shape and disposed in a lower part of the pair of flat portions 11. The self-standing packaging bag SPB has the two-layer portions TL composed of the pair of flat portions 11 and the four-layer portions FL composed of the pair of flat portions 11 and the bottom portion 12 folded in half into a two-ply form. The boundaries between the two-layer portions TL and the four-layer portions FL are step portions formed due to the overlapping of the films. In particular, step portions at boundaries along a bottom portion-forming film fold line 14 of the bottom portion 12 are the first step portions 31. The self-standing packaging bag SPB has the side seal portions 22 on opposite sides and bottom seal portions 21 at the bottom. The bottom seal portions 21 serve as lower end seals of the self-standing packaging bag SPB and also as seals that determine the shape of the bottom portion of the self-standing packaging bag SPB and are seal portions each including a lower end seal 21a disposed at the lower end of the self-standing packaging bag SPB and lineally extending in the width direction and a bottom shape-forming seal 21b formed integrally with the lower end seal 21a and including linear diagonal seals 21ba disposed on opposite sides and an arc-shaped seal 21bb disposed at the center. In the self-standing packaging bag SPB, unsealed first step portions 24a, unsealed second step portions 24b, and unsealed bottom portions 25 are formed according to the shape of the bottom seal portions 21. The unsealed first step portions 24a are unsealed portions that overlap the first step portions 31 and that include at least part thereof, and the unsealed second step portions 24b are unsealed portions that overlap the second step portions 32 formed due to the cut-out portions 13 formed in the bottom portion-forming film 12 and that include at least part of the second step portions 32. In the self-standing packaging bag SPB in FIG. 1, the unsealed bottom portions 25 that are unsealed portions between the bottom shape-forming seals 21b and the lower end seals 21a of the bottom seal portions 21 are formed in order to prevent the occurrence of wrinkles that can occur when the entire bottom portions including the bottom shape-forming seals 21b and the lower end seals 21a are sealed, and the unsealed bottom portions 25 contain the unsealed second step portions 24b. Specifically, the unsealed second step portions 24b and the unsealed bottom portions 25 are integrated together. The unsealed first step portions 24a are sealed due to the side seal portions 22 and special step seal portions 23 described later and are not unsealed portions in the self-standing packaging bag SPB. The opening shape of the bottom portion is determined by the bottom seal portions 21 and is a circular shape, an elliptical shape, etc., and the self-standing ability is thereby imparted to the self-standing packaging bag SPB.

### <Film>

No particular limitation is imposed on the film used for the method for producing the self-standing packaging bag SPB in the present embodiment so long as at least one surface of the film is formed of a heat-sealable layer and the innermost layer that becomes the inner surface of the self-standing packaging bag SPB can serve as a heat-sealable layer. For example, the film may be a single-layer film composed only of a heat-sealable layer or may be a laminate film including a heat-sealable layer disposed on at least one surface of a base layer. In the present embodiment, it is preferable to use a laminate film including a heat-sealable layer disposed on one surface of a base layer. This laminate film may include the base layer and the heat-sealable layer and may optionally include an intermediate layer etc. therebetween. In the laminate film, for example, the innermost layer that becomes the inner surface of the packaging bag is the heat-sealable layer, and the outermost layer that becomes the surface of the packaging bag is the base layer having heat resistance. One or more intermediate layers may be present between the base layer and the heat-sealable layer.

In a packaging bag produced using a single-layer film composed only of a heat-sealable layer, a sealing member comes into direct contact with the heat-sealable layer in a sealing step, so that the surface of the packaging bag is easily wrinkled. Therefore, by using a laminate prepared by laminating the heat-sealable layer and another layer such as a base layer, the occurrence of wrinkles formed on the surface of the packaging bag can be prevented.

### (Heat-Sealable Layer)

In the films used for the method for producing the self-standing packaging bag SPB in the present embodiment, the heat-sealable layers are layers that can be bonded together by the application of heat and pressure. No particular limitation is imposed on the resin forming the heat-sealable layers so long as it is a resin having heat sealability. For example, the resin is at least one selected from the group consisting of polyester-based resins, polyolefin-based resins, acrylic-based resins, vinyl acetate-based resins, polyamide-based resins, etc. In the present embodiment, the resin forming the heat-sealable layers contains a polyester-based resin.

When the resin containing a polyester-based resin is used as the resin forming the heat-sealable layers, the polyester-based resin is, for example, preferably a polyethylene terephthalate-based resin. By controlling the crystallinity of the polyester-based resin such as a polyethylene terephthalate-based resin, the polyester-based resin can exhibit heat sealability even when heated to a temperature lower than the melting point.

The film containing the polyester-based resin may be generally a polyester-based resin composition film prepared by forming a composition containing the polyester-based resin, a softener, a binder, and a forming aid into a film. The crystallinity of the polyester-based resin composition film can be controlled within a desired range by rapidly cooling the resin when the film is formed. By controlling the crystallinity, the polyester-based resin composition film can exhibit heat sealability even when heated to a temperature lower than the melting point. The polyester-based resin is resistant to adsorption of active ingredients of drugs, perfumes, etc. Therefore, it is unnecessary to use a two-layer laminate including a non-adsorptive layer and a heat-sealable layer, and both non-adsorptivity and heat sealability can be provided by using only the polyester-based resin composition film.

Examples of the polyester-based resin composition include a polyethylene terephthalate resin composition containing 100 parts by mass of polyethylene terephthalate, 0.1 parts by mass or more and 3 parts by mass or less of a styrene-(meth)methyl acrylate-glycidyl methacrylate copolymer used as the binder, 3 parts by mass or more and 20 parts by mass or less of a cyclohexanedimethanol-ethylene glycol-terephthalic acid condensation polymer (PCTG) used as the softener, and 0.05 parts by mass or more and 1.5 parts by mass or less of calcium stearate used as the forming aid. Polyethylene terephthalate having an intrinsic viscosity of, for example, 0.6 dL/g or more and 0.8 dL/g or less can be used. The epoxy value of the styrene-(meth)methyl acrylate-glycidyl methacrylate copolymer is, for example, 0.5 meq/g or more and 4.0 meq/g or less.

The range of the crystallinity of the polyester-based resin in which the heat-sealable layer containing the polyester-based resin can exhibit heat sealability even when heated to a temperature lower than the melting point is, for example, 30% or less, preferably 25% or less, more preferably 20% or less, and still more preferably 18% or less. The lower limit may be 0%. The crystallinity of the polyester-based resin in the present embodiment is within the above range. The crystallinity is computed by dividing the heat of fusion when the polyester is fused using a differential scanning calorimeter (DSC: differential scanning calorimetry) by the heat of fusion of a perfect crystal (140 J/g for polyethylene terephthalate) and multiplying the quotient by 100.

The above chemical composition of the polyester-based resin in the heat-sealable layer is an example and is not a limitation. The resin in the heat-sealable layer is not limited to the polyester-based resin. In the present embodiment, the resin forming the heat-sealable layer contains the polyester-based resin. However, any heat-sealable layer can be preferably used.

### (Base Layer)

In the film used for the method for producing the self-standing packaging bag in the present embodiment, no particular limitation is imposed on the base layer of the laminate film, and a base layer having good mechanical suitability and good printing suitability is preferably used. Examples of such a base layer include: synthetic resin films such as polyester-based resin films (such as polyethylene terephthalate-based resin films), polyamide-based resin films (such as nylon-based resin films), polyolefin-based resin films (such as polypropylene-based resin films), cyclic olefin-based resin films (such as polynorbornene-based resin films and polydicyclopentadiene-based resin films), polyvinyl alcohol-based resin films (such as polyvinyl alcohol-based resin films and ethylene-vinyl alcohol copolymer-based resin films), polycarbonate-based resin films, and polyacetal-based resin films; multilayer films produced by coextruding any of the above resins; laminates of any of the above resins or films; nonwoven fabrics; paper; and metal foils.

These films may be non-stretched films or may be uniaxially or biaxially stretched films.

The film used for the base layer may be a vapor-deposited film including a vapor-deposited layer. The vapor-deposited layer is, for example, one or more types of inorganic materials selected from the group consisting of aluminum, silicon oxide, aluminum oxide, indium oxide, tin oxide, zirconium oxide, magnesium oxide, etc.

No particular limitation is imposed on the thickness of the base layer. The thickness is, for example, 3 μm or more, preferably 5 μm or more, more preferably 6 μm or more, and yet more preferably 9 μm or more and is, for example, 100 μm or less, preferably 60 μm or less, and more preferably 50 μm or less.

### (Intermediate Layer)

In the film used for the method for producing the self-standing packaging bag in the present embodiment, it is preferable from the viewpoint of protection of the contents that the intermediate layer of the laminate film is formed of a material having a barrier ability. Examples of the barrier ability include the ability to shield light such as visible rays and ultraviolet rays, the barrier ability to block gases such as oxygen and water vapor, and the heat shielding ability to shield heat. A material having a desired function selected from these barrier abilities is used as the intermediate layer.

No particular limitation is imposed on the material having the barrier ability. Examples of the material include: foils of metals such as aluminum, iron, copper, and tin; and films of polyvinyl chloride, polycarbonate, polyvinyl alcohol, saponified ethylene-vinyl acetate copolymers, polyvinylidene chloride, etc. Other examples include: films prepared by coating the films described for the base layer with polyvinylidene chloride; films prepared by vapor-depositing inorganic materials such as aluminum, silicon oxide, aluminum oxide, indium oxide, tin oxide, zirconium oxide, and magnesium oxide onto the above films; and nonwoven fabric and foamed films having heat insulating properties.

The intermediate layer may have various functions in addition to the barrier ability or instead of the barrier ability. The function that the intermediate layer has can be appropriately selected from, for example, mechanical toughness, bending resistance, penetration resistance, shock resistance, cold resistance, heat resistance, chemical resistance, tear resistance, etc. according to the necessary and/or required function.

The film used as the intermediate layer may be a non-stretched film or may be a uniaxially or biaxially stretched film. The number of intermediate layers may be one or may be two or more.

No particular limitation is imposed on the thickness of the intermediate layer. The thickness is, for example, 1 μm or more, preferably 3 μm or more, and more preferably 5 μm or more and is, for example, 50 μm or less, preferably 30 μm or less, and more preferably 20 μm or less.

(Lamination method for laminate film)

When a laminate film is used as the film used for the method for producing the self-standing packaging bag in the present embodiment, no particular limitation is imposed on the method for laminating the base layer, the heat-sealable layer, and the optional intermediate layer that form the laminate film. For example, a previously known lamination method such as a dry lamination method, an extrusion lamination method, a non-solvent lamination method, a thermal lamination method, or a coextrusion method can be applied, and a combination of a plurality of lamination methods may be used as needed.

When a heat-sealable layer having heat sealability imparted by controlling the crystallinity of the polyester-based resin is used, the heat sealability may be affected when heat is applied during the lamination treatment. Therefore, a lamination method such as a dry lamination method or a non-solvent lamination method that does not facilitate the crystallization of the polyester is preferred.

### Method for Producing Self-Standing Packaging Bag in Embodiment

The method for producing the self-standing packaging bag SPB in the present embodiment is a method used mainly to produce a self-standing packaging bag in which the resin forming the heat-sealable layer of the films contains a polyester-based resin. Next, the method for producing the self-standing packaging bag SPB in the present embodiment, in particular the method for producing the self-standing packaging bag SPB in which the heat-sealable layer of the films contains a polyester-based resin, will be described. More specifically, a method for continuously producing self-standing packaging bags SPB will be described.

FIG. 2 is a schematic illustration in which a pair of flat portion-forming films 11 and a pair of bottom portion-forming films 12 folded in half that overlap each other are conveyed such that self-standing packaging bags SPB can be continuously produced with upper openings Ap of two self-standing packaging bags SPB abutting each other. In FIG. 2, each film is conveyed to the left side from unillustrated film rolls on the right side, and self-standing packaging bags SPB are produced in pairs with the upper openings Ap abutting each other in the width direction of the flat portion-forming films 11.

The pair of flat portion-forming films 11 are conveyed such that the heat-sealable layers face each other. The pair of flat portion-forming films 11 are conveyed such that the bottom portion-forming films 12 folded in half along the bottom portion-forming film fold lines 14 in the conveying direction with the heat-sealable layers on the front side are held between the pair of flat portion-forming films 11 in opposite side portions with respect to the conveying direction with the bottom portion-forming film fold lines 14 opposed to each other. In the bottom portion-forming films 12, the cut-out portions 13 are formed at regular intervals.

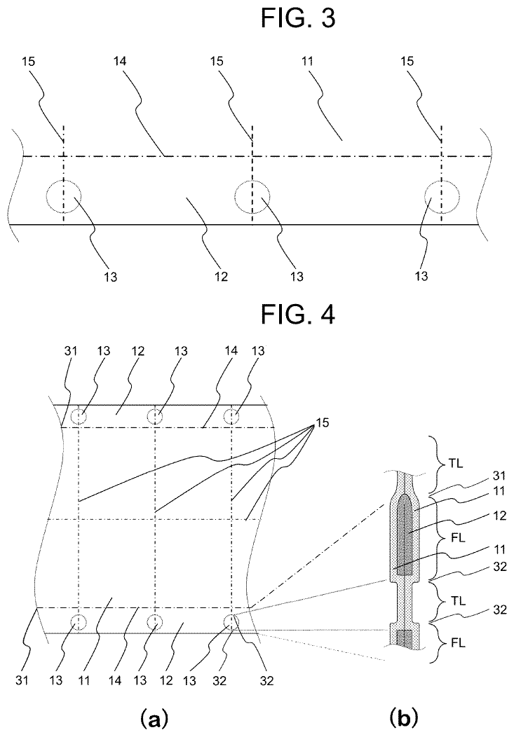

FIG. 3 is a schematic illustration of a bottom portion-forming film 12 folded in half and held between the pair of flat portion-forming films 11. In FIG. 3, cutting lines 15 are boundary lines between packaging bags when the self-standing packaging bags SPB are produced and are lines along which the packaging bags are to be cut after sealing. As shown in FIG. 3, in the bottom portion-forming films 12, the cut-out portions 13 are formed at regular intervals at positions on opposite sides of the self-standing packaging bags after the bottom portion-forming films 12 are unrolled from the film rolls.

As shown in FIGS. 2 and 4 (a), the pair of flat portion-forming films 11 and the bottom portion-forming films 12 folded in half are stacked during conveyance. In this manner, the first step portions 31 in which the bottom portion-forming film fold lines 14 of the bottom portion-forming films 12 folded in half serve as boundaries are formed, and the second step portions 32 in which the edges of the cut-out portions 13 serve as boundaries are formed.

FIG. 4 (b) is a cross-sectional view of a state in which the pair of flat portion-forming films 11 and a bottom portion-forming film 12 folded in half are stacked with the bottom portion-forming film 12 inserted therebetween. As shown in FIG. 4 (b), a first step portion 31 is formed with the bottom portion-forming film fold line 14 serving as a boundary and is formed at the boundary between a two-layer portion TL composed of the pair of flat portion-forming films 11 and a four-layer portion FL composed of the pair of flat portion-forming films 11 and a bottom portion-forming film 12 folded in half and held between the flat portion-forming films 11. Each second step portion 32 is formed in a four-layer portion FL composed of the pair of flat portion-forming films 11 and a bottom portion-forming film 12 folded in half and held between the flat portion-forming films 11 and is formed due to a cut-out portion 13 formed in the bottom portion-forming film 12 at the edge of the cut-out portion 13 that serves as the boundary between the four-layer portion FL and the two-layer portion TL. The cross-sectional view of each first step portion 31 is the same as that of the related art shown in FIG. 14.

As described above, in the method for producing the self-standing packaging bag in the present embodiment, the bottom portion-forming films 12 folded in half are held between the pair of flat portion-forming films 11 so as to overlap each other as shown in FIG. 4 (b), and the bottom seal portions 21 are first formed in a first sealing step.

### (First Sealing Step)

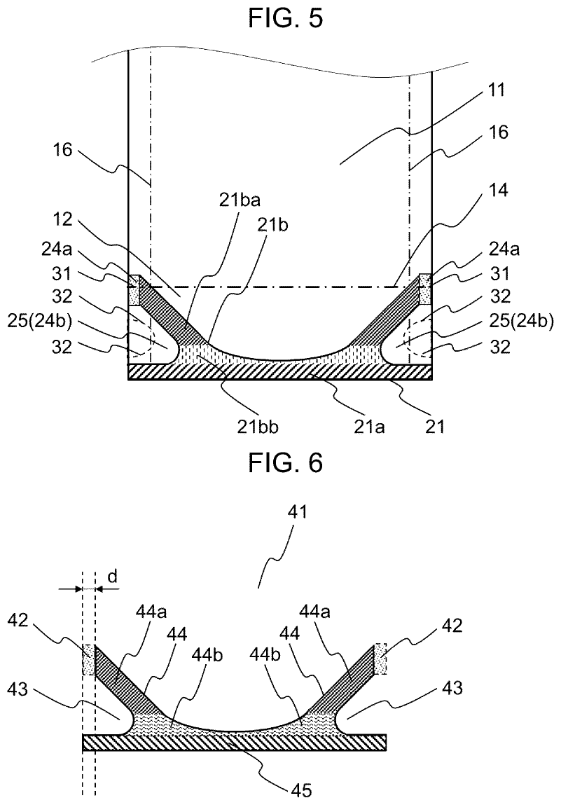

In the first sealing step in the present embodiment, the bottom seal portions 21 are formed. FIG. 5 shows a schematic illustration of the first sealing step. FIG. 5 is an illustration of one of the self-standing packaging bags SPB produced continuously. The bottom seal portions 21 serve as lower end seals of the self-standing packaging bag SPB and also as seals that determine the shape of the bottom portion of the self-standing packaging bag SPB, and the details of the overall shape will be described later. In the first sealing step, regions including parts of the first step portions 31 overlapping the side seal portions 22 to be sealed later are heated and pressurized and then cooled to form the bottom seal portions 21. In this case, regions including at least parts of the rest of the first step portions 31 that extend along the bottom portion-forming film fold line 14 and overlap the side seal portions 22 to be sealed later are not sealed to thereby form the unsealed first step portions 24a. In FIG. 5, regions between the left and right edges of the self-standing packaging bag SPB and side seal portion boundary lines 16 are portions that are to become the respective left and right side seal portions 22. In the bottom seal portions 21, the entire first step portions 31 overlapping the side seal portions 22 may be unsealed at all. However, when only parts of the first step portions 31 overlapping the side seal portions 22 are sealed, the flat portion-forming films 11 and the bottom portion-forming films 12 are unlikely to be misaligned, which is preferred. A sealing member that is a heat sealing die used to form the bottom seal portions 21 has a shape that allows regions including at least parts of the first step portions 31 overlapping the side seal portions 22 to remain unsealed to thereby form the unsealed first step portions 24a and allows regions including parts of the first step portions 31 overlapping the side seal portions 22 other than the unsealed first step portions 24a to be sealed. The details of the sealing member will be described later.

In the method for producing the self-standing packaging bag in the present embodiment, when the heat-sealable layers containing the polyester-based resin and used in the films are heated and pressurized at a temperature lower than or equal to the melting point of the polyester-based resin, the films are bonded together. Then, when the resulting films are cooled, the films are sealed together while the heat fusion properties of the resin are lost. Once the films have cooled, the polyester-based resin does not remelt even when the films are again heated. Therefore, when a self-standing packaging bag using the heat-sealable layers containing the polyester-based resin is produced, if the entire regions of the first step portions 31 overlapping the side seal portions 22 in the conventional bottom seal portions 21C are sealed as in the conventional case, the films may not be sufficiently bonded together on the two-layer portion TL side in the first step portions 31. When the films are not sufficiently bonded together as described above, molecules in these regions are crystallized, and the degree of crystallinity increases, so that the heat fusion properties are lost. Even when the first step portions 31 in which the films are not sufficiently bonded together are heated again in the subsequent sealing step, the already crystallized molecules retain their crystal structure.

Therefore, the heat fusion properties are not recovered, and the bonding between the films remains insufficient. In this case, it is feared that the seals in the insufficiently bonded potions in a self-standing packaging bag to be formed may be defective.

In the method for producing the self-standing packaging bag SPB in the present embodiment, the bottom seal portions 21 are heated and pressurized and then cooled in the first sealing step such that the regions including at least parts of the first step portions 31 overlapping the side seal portions 22 remain unsealed to thereby form the unsealed first step portions 24a. At this point, the heat-sealable layers in the unsealed first step portions 24a are not heat-sealed, so that the crystallization of the polyester-based resin in the heat-sealable layers in the unsealed first step portions 24a can be prevented. At the completion of the heating and pressurization and the subsequent cooling in the first sealing step, the unsealed first step portions 24a are unsealed portions in which the films are not bonded together at all. The unsealed first step portions 24a will be firmly sealed by heating, pressurizing, and cooling only once in the final sealing step after the second sealing step described later.

Similarly, in the first sealing step in the present embodiment, regions including the second step portions 32 are not sealed, and the bottom seal portions 21 including the unsealed second step portions 24b are formed. At this point, in the unsealed second step portions 24b, the heat-sealable layers in the pair of flat portion-forming films 11 in the two-layer portions TL are not bonded together, and the heat-sealable layers in the flat portion-forming films 11 and the bottom portion-forming film 12 in the four-layer portions FL are not bonded together, so that the crystallization of the polyester-based resin in the heat-sealable layers can be prevented. At the completion of the first sealing step, the unsealed second step portions 24b are unsealed portions in which the films are not bonded together at all.

FIG. 6 shows a bottom portion-forming sealing member 41 for forming the bottom seal portions 21 in the first sealing step. The bottom seal portions 21 serve as the lower end seals of the self-standing packaging bag SPB and serve also as seals that determine the shape of the bottom portion of the self-standing packaging bag SPB. No particular limitation is imposed on the shape etc. of the bottom seal portions 21 so long as the bottom surface of the self-standing packaging bag SPB can be formed. In FIG. 5, each of the bottom seal portions 21 is a seal portion including a lower end seal 21a disposed at the lower end of the self-standing packaging bag SPB and lineally extending in the width direction and a bottom shape-forming seal 21b formed integrally with the lower end seal 21a and including linear diagonal seals 21ba disposed on opposite sides and an arc-shaped seal 21bb disposed at the center. The lower end seal 21a partially overlaps the arc-shaped seal 21bb. The unsealed first step portions 24a are located on the outer sides of the diagonal seals 21ba, and portions between the bottom shape-forming seal 21b and the lower end seal 21a are the unsealed second step portions 24b. In the first sealing step, the bottom seal portions 21 are first formed. In this manner, the pair of flat portion-forming films 11 and the bottom portion-forming film 12 are prevented from being misaligned.

The bottom portion-forming sealing member 41 shown in FIG. 6 and used in the first sealing step is a heat sealing die used to form the bottom seal portions 21, has the same shape as the shape of the bottom seal portions 21, and includes a bottom shape-forming seal-forming portion 44 for forming the bottom shape-forming seals 21b and a lower end seal-forming portion 45 for forming the lower end seals 21a. The bottom portion-forming sealing member 41 has step portion notches 42 that can form the unsealed first step portions 24a in which at least parts of the step portions formed due to the overlapping of the films are not sealed. The bottom portion-forming sealing member 41 shown in FIG. 6 is designed such that at least part of each of the first step portions 31 and the second step portions 32 is not sealed. In the bottom portion-forming sealing member 41, the step portion notches 42 for forming the unsealed first step portions 24a are formed so as to correspond to the first step portions 31, and side notches 43 for forming the unsealed second step portions 24b are formed so as to correspond to the second step portions 32. In FIG. 6, the bottom portion-forming sealing member 41 has a shape designed such that the side notches 43 allow the entire second step portions 32 to remain unsealed. However, it is only necessary that at least part of each of the second step portions 32 be not sealed. When the entire bottom seal portions 21 are sealed flatly, it is feared that wrinkles may be formed. Therefore, in addition to the side notches 43 formed so as to avoid the second step portions, unillustrated notches for forming the unsealed bottom portions 25 may be provided. The notches for forming the unsealed bottom portions 25 may be formed separately from the side notches 43 or may be formed integrally with the step portion notches 42 and/or the side notches 43.

The second step portions 32 are not associated with the content-containing portion of the self-standing packaging bag SPB, and it is unnecessary that the second step portions 32 be sealed such that their seal strength is strong enough to reliably seal the steps, as is required for the first step portions 31. Therefore, it is not always necessary to form the side notches 43 in the bottom portion-forming sealing member 41, and the unsealed second step portions 24b may not be formed in the first sealing step. When the side notches 43 and the notches for forming the unsealed bottom portions 25 are not formed in the bottom portion-forming sealing member 41 and then the entire bottom seal portions 21 are sealed flatly, it is feared that wrinkles may be formed as described above. It is therefore preferable to provide notches that allow at least parts of the second step portions 32 to remain unsealed.

In the present embodiment, the side seal portions 22 are to be sealed in the subsequent step, and the pair of flat portion-forming films 11 are to be bonded together through the cut-out portions 13 in the bottom portion-forming film 12 to close the side portions of the self-standing packaging bag SPB. Therefore, it is desirable that, in the first sealing step, portions of the flat portion-forming films 11 that correspond to the cut-out portions 13 are not bonded together in order to prevent the crystallization of the polyester resin in the heat-sealable layers during the first sealing step. To achieve this, it is preferable that the bottom portion-forming sealing member 41 has the side notches 43 that allow the bottom seal portions 21 to be formed such that at least parts of the second step portions 32 overlapping the side seal portions 22 remain unsealed and also has the notches for forming the unsealed bottom portions 25.

The step portion notches 42 are provided in the bottom portion-forming sealing member 41 in order to form the unsealed first step portions 24a. Specifically, when the bottom portion-forming sealing member 41 is used in the first sealing step, the unsealed first step portions 24a are formed, and regions including at least parts of the first step portions 31 overlapping the side seal portions 22 remain unsealed. For example, as shown in FIG. 6, the step portion notches 42 in the bottom portion-forming sealing member 41 are formed such that the positions of the opposite edges of diagonal seal-forming portions 44a of the bottom shape-forming seal-forming portion 44 are located at positions spaced inward by a width dimension d from the opposite edges of the lower end seal-forming portion 45, and portions having a width dimension d and located on the outer sides of the diagonal seal-forming portions 44a serve as the step portion notches 42. The bottom seal portions 21 formed using the bottom portion-forming sealing member 41 each have a shape in which the diagonal seals 21ba extend to regions overlapping the side seal portions 22 of the self-standing packaging bag SPB to be produced and do not reach the positions of the opposite edges of the flat portions 11. In this manner, portions between the opposite edges of the diagonal seals 21ba and the opposite side edges of the flat portions 11 serve as the unsealed first step portions 24a including parts of the first step portions 31, and the unsealed first step portions 24a are formed so as to remain unsealed. The shape of the step portion notches 42 is not limited to the above shape, and it is only necessary that the step portion notches 42 have a shape that allows unsealed portions to be formed such that at least parts of the first step portions 31 overlapping the side seal portions 22 are included in the unsealed first step portions 24a. In FIG. 6, the bottom portion-forming sealing member 41 has a shape in which the opposite edges of the diagonal seal-forming portions 44a extend linearly in the upper-lower direction. However, for example, the opposite edges of the diagonal seal-forming portions 44a may each have a concave or convex arc shape or a linear shape extending obliquely. The bottom portion-forming sealing member 41 may have a shape that allows the bottom seal portions 21 to be formed such that the unsealed first step portions 24a are surrounded by seal portions and that parts of the first step portions 31 overlapping the side seal portions 22 are unsealed portions.

In the bottom portion-forming sealing member 41, no particular limitation is imposed on the size of the step portion notches 42 that allow the unsealed first step portions 24a to be formed in regions including at least parts of the first step portions 31.

Preferably, the step portion notches 42 in the bottom portion-forming sealing member 41 shown in FIG. 6 are designed such that the ratio of the width of the unsealed part of each side seal portion 22 to the width of the side seal portion 22 is, for example, 80% or less, preferably 70% or less, and more preferably 50% or less and is, for example, 5% or more, preferably 10% or more, and more preferably 20% or more.

In the bottom portion-forming sealing member 41 shown in FIG. 6, the side notches 43 for forming the unsealed second step portions 24b in regions including the second step portions 32 may be provided. When the side notches 43 are provided, it is preferable that the side notches 43 are designed such that the ratio of the length of the unsealed part of each second step portion 32 to the full length of the second step portion 32 is, for example, 100% or less, preferably 80% or less, more preferably 70% or less, and still more preferably 50% or less and is, for example, 0% or more, preferably 5% or more, more preferably 10% or more, and still more preferably 20% or more.

The heating temperature in the first sealing step for forming the bottom seal portions 21 is appropriately set according to the resin in the heat-sealable layers. In the present embodiment, the heat-sealable layers contain the polyester-based resin, and the heating temperature is lower than or equal to about 260° C. that is the melting point of the polyester-based resin and can be, for example, 130° C. or higher and 160° C. or lower. In the flat portion-forming films 11 and/or the bottom portion-forming film 12, layers other than the heat-sealable layers may be formed of a polyester-based resin or an olefin-based resin. In this case, if the heating temperature is higher than or equal to the melting point of the polyester-based resin, the resin in these layers also melts. It is therefore preferable to perform the heating at a temperature lower than the melting point of the polyester-based resin.

The polyester-based resin is used for the heat-sealable layers and heated to a temperature lower than the melting point of the polyester, so that the polyester-based resin is softened to bond the films together. This may be because the motion of the molecules of the amorphous polyester is activated and the amorphous molecules are entangled, so that the films are bonded together. By cooling the bonded portions of the films, the strong seal portions are formed.

In the first sealing step, the bottom portion-forming sealing member 41 is used for the heating and pressurization and the subsequent cooling, and the strong bottom seal portions 21 are thereby formed.

In the first sealing step, if the cooling is not performed after the heating and pressurization, it is feared that the flat portion-forming films 11 and the bottom portion-forming film 12 may be misaligned with each other and residual heat may cause portions not intended to be sealed to be bonded together. Therefore, the cooling must be performed after the heating and pressurization.

At the completion of the first sealing step, the unsealed second step portions 24b remain as unsealed portions in which the films are not bonded together at all.

### (Second Sealing Step)

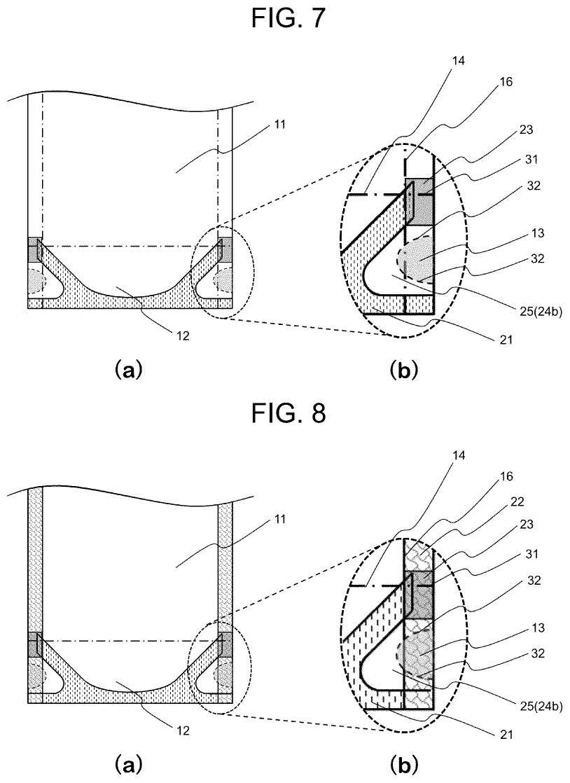

FIG. 7 (a) is a schematic illustration of the second sealing step performed after the first sealing step, and FIG. 7 (b) is an enlarged view of a portion surrounded by a circle in FIG. 7 (a). As shown in FIGS. 7 (a) and 7 (b), the special step seal portions 23 are formed in the second sealing step.

The second sealing step is the step of intensively heating and pressurizing the unsealed first step portions 24a including the first step portions 31 and not sealed in the first sealing step to thereby seal the unsealed first step portions 24a.

The special step seal portions 23 formed in the second sealing step are located in regions within the side seal portions 22 to be sealed later and are regions including the unsealed first step portions 24a not sealed in the first sealing step.

No particular limitation is imposed on the heating temperature in the second sealing step. To perform the sealing intensively, the heating temperature is preferably lower than or equal to the melting point of the polyester-based resin in the heat-sealable layers and higher than the heating temperature in the first sealing step. The heating temperature is, for example, 150° C. or higher, preferably 170° C. or higher, and more preferably 200° C. or higher and is, for example, 240° C. or lower and preferably 230° C. or lower.

Preferably, the special step seal portions 23 formed in the second sealing step partially overlap the bottom seal portions 21 formed in the first sealing step in order to prevent the occurrence of unsealed portions not sealed in the first sealing step and also in the second sealing step due to misalignment of the sealing positions.

No particular limitation is imposed on the shape and size of the special step seal portions 23 formed in the second sealing step so long as both the two-layer portions TL and the four-layer portions FL can be sufficiently heated and pressurized at positions near the first step portions 31 and the unsealed first step portions 24a including the first step portions 31 and formed in the first sealing step can be firmly bonded within the side seal portions 22 to be sealed later. For example, the special step seal portions 23 have the same width as the width of the side seal portions 22 to be sealed later and each have preferably a quadrilateral shape with a height in the upper-lower direction of about 10 mm to about 30 mm, an elliptic shape, etc. A sealing member suitable for the shape of the seals is used in the second sealing step.

After the second sealing step, no cooling is performed. Then a third sealing step is performed to form the side seal portions 22 such that the side seal portions 22 contain the special step seal portions 23 formed in the second sealing step. In the third sealing step, cooling is performed after heating and pressurization. No cooling is performed after the second sealing step. Therefore, in the regions of the special step seal portions 23 formed as the unsealed first step portions 24a in the first sealing step and then sealed in the second sealing step, the increase in the degree of crystallization of the polyester-based resin in the heat-sealable layers can be suppressed even after the second sealing step.

The second step portions 32 formed due to the cut-out portions 13 formed in the opposite side edge portions of the bottom portion-forming film 12 are not in communication with the content-containing portion. Therefore, it is unnecessary to form strong seals, and it is unnecessary to seal the second step portions 32 in the second sealing step. However, the second step portions 32 may be sealed in the second sealing step.

### (Third Sealing Step)

FIG. 8 (a) is a schematic illustration of the third sealing step performed after the second sealing step, and FIG. 8 (b) is an enlarged view of a portion surrounded by a circle in FIG. 8 (a).

The third sealing step is the step of sealing opposite side portions of the self-standing packaging bag SPB to form the side seal portions 22. In the third sealing step, regions including the special step seal portions 23 formed in the second sealing step are heated and pressurized and then cooled to thereby form the side seal portions 22.

No particular limitation is imposed on the heating temperature in the third sealing step. The heating temperature is, for example, 150° C. or higher, preferably 170° C. or higher, and more preferably 180° C. or higher and is, for example, 230° C. or lower, preferably 220° C. or lower, and more preferably 210° C. or lower.

No particular limitation is imposed on the shape and size of the side seal portions 22 formed in the third sealing step so long as the opposite side portions of the self-standing packaging bag SPB can be reliably sealed. The side seal portions 22 extend substantially linearly from the upper end of the self-standing packaging bag SPB to the lower end in the upper-lower direction, and the width of the side seal portions 22 is preferably 5 mm or more and 30 mm or less. A sealing member suitable for the shape of these seals is used to form the side portions in the third sealing step.

In the third sealing step, a side portion-forming sealing member is used to perform heating and pressurization, and then cooling is performed to firmly seal the special step seal portions 23 formed in the second sealing step and the side seal portions 22 formed in the third sealing step. The unsealed first step portions 24a are heated and pressurized twice in the second and third sealing steps with no cooling performed between the two sealing steps and then cooled after the third sealing step. Therefore, the strong special step seal portions 23 are formed as a result of the third sealing step.

### (Cutting Step)

In the present embodiment, the following cutting step is performed. Cutting is performed along the cutting lines 15 to obtain individual self-standing packaging bags SPB, and the self-standing packaging bag SPB shown in FIG. 1 is thereby obtained. Each self-standing packaging bag SPB obtained is filled with the contents from the upper opening Ap. Then the upper opening Ap is sealed, and a self-standing package can thereby be obtained.

The method for producing the self-standing packaging bag in the present embodiment is not limited to the production method including sealing the special step seal portions 23 by heating and pressurization in the second sealing step, sealing the side seal portions 22 by heating and pressurization in the third sealing step, and then performing cooling.

For example, a production method including heating and pressurizing the side seal portions 22 in the second sealing step without cooling, sealing the special step seal portions 23 by heating and pressurization in the third sealing step, and then cooling the regions of the side seal portions 22 may be used.

As described above, with the method for producing the self-standing packaging bag in the present embodiment, even when the films used each include the heat-sealable layer containing the polyester-based resin including amorphous portions, regions around the first step portions 31 formed due to the overlapping of the films can be reliably sealed. In the self-standing packaging bag produced by this production method, the appearance of the first step portions 31 is good. Even after the packaging bag is filled with the contents, the occurrence of leakage of the contents can be prevented.

The method for producing the self-standing packaging bag in the present invention uses a bag making machine including a plurality of sets of sealing jigs for performing heating, pressurization, and then cooling. In the method for producing the self-standing packaging bag in the present invention, the above-described heating and pressurization and the subsequent cooling in the first sealing step are performed using a first set of sealing jigs, and the heating and pressurization in the second and third sealing steps and the subsequent cooling are performed using a second set of sealing jigs, which is the last set of sealing jigs.

This will be described in detail. First, the first set of sealing jigs is used in the first sealing step to perform heating and pressurization and then perform cooling to thereby form the bottom seal portions 21 such that the unsealed first step portions 24a are formed in which regions overlapping the side seal portions 22 of the self-standing packaging bag SPB and including parts of the first step portions 31 remain unsealed. As described above, at this point, the films in the unsealed first step portions 24a have not been bonded together. This is because, since the heat-sealable layer of each of the films used for the self-standing packaging bag SPB in the present embodiment contains the polyester-based resin, it is necessary to prevent the crystallization of the polyester-based resin at this point. Since the first set of sealing jigs is used to perform the cooling, the strong bottom seal portions 21 are formed. Then the second set of sealing jigs, i.e., the last set of sealing jigs, is used to heat and pressurize the regions described above and the side portions of the self-standing packaging bag SPB in the second and third sealing steps and then perform cooling to thereby form the special step seal portions 23 and the side seal portions 22. At this point, the strong seals have been formed in all the bottom seal portions 21, the special step seal portions 23, and the side seal portions 22, and the first step portions 31 can be reliably sealed. The appearance of the first step portions 31 is good. Moreover, even after the self-standing packaging bag SPB formed is filled with the contents, the occurrence of leakage of the contents can be prevented.

As described above, the method for producing the self-standing packaging bag in the present embodiment is applicable even when the films used include the heat-sealable layers containing the polyester-based resin including amorphous portions. In this method, the first set of sealing jigs is used to form seals. Specifically, heating and pressurization are performed at a temperature lower than or equal to the melting point of the polyester-based resin such that the step portions formed due to the overlapping of the films are intentionally not sealed, and then cooling is performed. Then second set of sealing jigs, which is the last set of sealing jigs, is used to perform heating and pressurization and then cooling to thereby seal the regions including the step portions not sealed by the first set of sealing jigs. In this manner, the step portions can be reliably bonded, and the occurrence of faulty seals that may lead to leakage of the contents from the self-standing packaging bag can be prevented.

Moreover, in the method for producing the self-standing packaging bag in the present embodiment, it is unnecessary to separately provide the ultrasonic sealing mechanism or the high-frequency dielectric sealing mechanism described in PTL 3, and this is advantageous in terms of the cost and maintenance of the bag making machine. When ultrasonic sealing or high-frequency dielectric sealing is used, the seal portions may be significantly reduced in thickness, and the strength of these portions may decrease. However, with the method in the present embodiment, this can be prevented. Moreover, the formation of resin clusters, which occur when the molten resin in the heat-sealable layers in the thinned portions flows into the content-containing portion, can be prevented. Since no ultrasonic sealing marks or high-frequency dielectric sealing marks are formed, the appearance of the produced self-standing packaging bag SPB is good.

### [Sealing Member]

The sealing member according to the present invention is a heat sealing die used to form the bottom seal portions in the first sealing step of the method for producing the self-standing packaging bag and is a bottom portion-forming sealing member. The details of the sealing member according to the present invention are as described above. The sealing member has a shape having notches so that at least part of the step portions formed due to the overlapping of the films are not sealed.

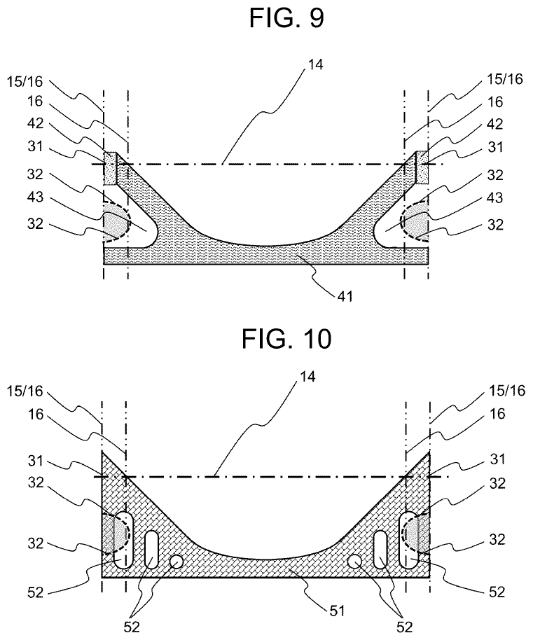

FIG. 9 is a schematic illustration of a bottom portion-forming sealing member 41 used as a sealing member in an embodiment of the invention, and the sealing member 41 is a sealing member for forming bottom seal portions that is used to produce the self-standing packaging bag SPB shown in FIG. 1. The sealing member shown in FIG. 9 is the same as the bottom portion-forming sealing member 41 in the embodiment shown in FIG. 6.

FIG. 10 is a schematic illustration of a conventional bottom portion-forming sealing member 51 that is a sealing member in a related art and is a sealing member for forming bottom seal portions that is used to product the conventional self-standing packaging bag SPB-C shown in FIG. 12.

As shown in FIG. 9, the bottom portion-forming sealing member 41 for the self-standing packaging bag SPB has at least the step portion notches 42 at positions corresponding to the first step portions 31 that are formed due to the overlapping of the films at the boundaries between the two-layer portions TL including the pair of flat portion-forming films 11 and the four-layer portions FL including the pair of flat portion-forming films 11 and the bottom portion-forming film 12 folded in half and held between the pair of flat portion-forming films 11. When the bottom portion-forming film 12 has the cut-out portions 13, the bottom portion-forming sealing member 41 has the side notches 43 at positions corresponding to the second step portions 32 that are located within the regions in which the bottom portion-forming film 12 folded in half is held between the pair of flat portion-forming films 11 and that are formed due to the overlapping of the films at the boundaries between the two-layer portions TL that correspond to the pair of flat portion-forming films 11 in the cut-out portions 13 at the opposite ends of the bottom portion-forming film 12 and the four-layer portions FL other than the cut-out portions 13 of the bottom portion-forming film 12. In FIG. 9, the side notches 43 formed at the positions corresponding to the second step portions 32 are formed integrally with the step portion notches 42. However, the side notches 43 and the step portion notches 42 may be formed independently.

In the present invention, the step portion notches 42 and the side notches 43 of the bottom portion-forming sealing member 41 can each have any shape etc.

In the bottom portion-forming sealing member 41 in the invention, no particular limitation is imposed on the size of the step portion notches 42 used to form the unsealed first step portions 24a in the regions including at least parts of the first step portions 31.

Preferably, the step portion notches 42 in the bottom portion-forming sealing member 41 shown in FIG. 9 are designed such that the ratio of the unsealed width of each of the unsealed first step portions 24a to the width of one of the side seal portions 22 is, for example, 80% or less, preferably 70% or less, and more preferably 50% or less and is, for example, 5% or more, preferably 10% or more, and more preferably 20% or more.

The bottom portion-forming sealing member 41 shown in FIG. 9 may have the side notches 43 for forming the unsealed second step portions 24b in regions including the second step portions 32. When the side notches 43 are provided, it is preferable that the side notches 43 are designed such that the ratio of the unsealed length of each unsealed second step portion 24b to the full length of the second step portion 32 is, for example, 100% or less, preferably 80% or less, more preferably 70% or less, and still more preferably 50% or less and is, for example, 0% or more, preferably 5% or more, more preferably 10% or more, and still more preferably 20% or more.

In the present invention, no particular limitation is imposed on the material forming the bottom portion-forming sealing member 41 so long as seals can be formed by heating and pressurizing the heat-sealable layer. Examples of the material include metals such as iron, stainless steel, aluminum, and aluminum alloys, ceramics, mixtures thereof, and combinations thereof.

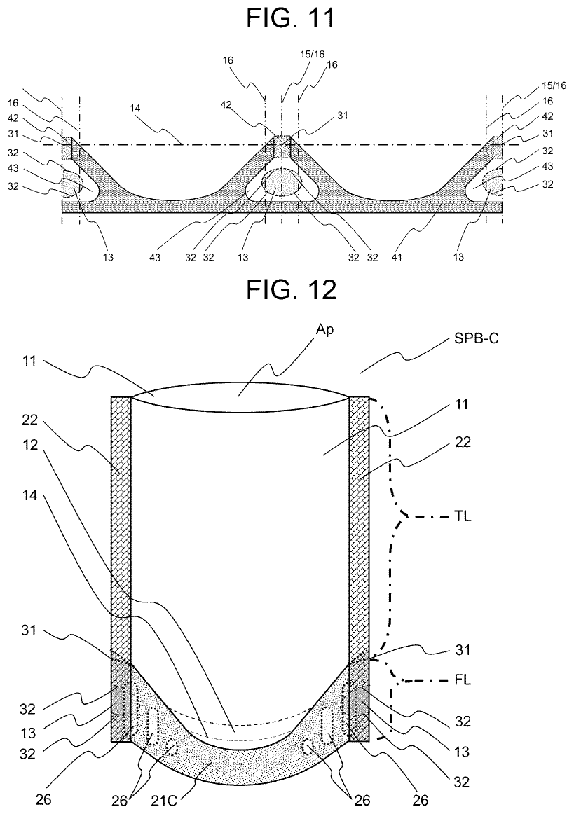

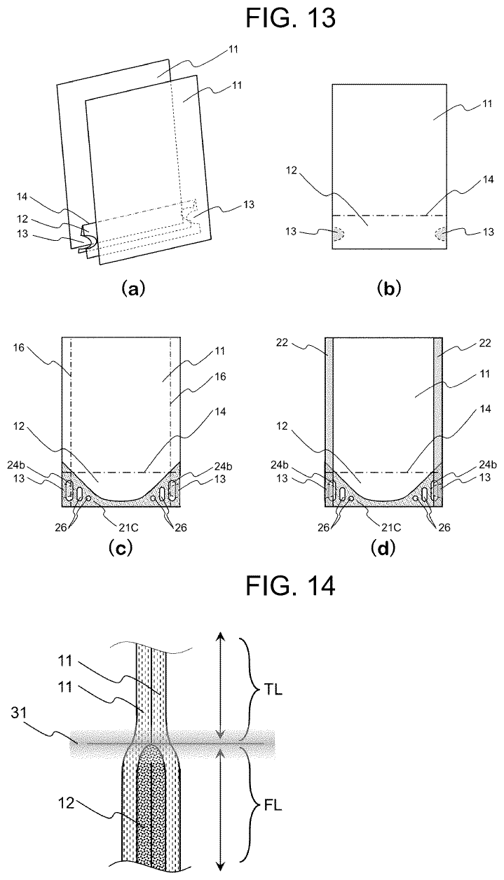

The bottom portion-forming sealing member 41 for the self-standing packaging bag shown in FIGS. 6 and 9 is used to produce one bag at a time. For example, as shown in FIG. 11, a bottom portion-forming sealing member may be formed such that two bags can be produced in one sealing operation or two or more bags can be produced in one sealing operation.

The present invention has been described using the embodiments. However, the technical scope of the invention is not limited to the scope of the above embodiments. Various changes or modifications can be made to the embodiments without departing from the scope of the invention, and the modes including the changes or modifications are also included in the technical scope of the invention. The embodiments may be combined appropriately. In particular, the method for producing the self-standing packaging bag using the films containing the polyester-based resin in their heat-sealable layer has been described. However, the heat-sealable layer of each film may not contain the polyester-based resin.

### REFERENCE SIGNS LIST

SPB self-standing packaging bag
SPB-C conventional self-standing packaging bag
Ap upper opening
11 flat portion/flat portion-forming film
12 bottom portion/bottom portion-forming film
13 cut-out portion
14 bottom portion-forming film fold line
15 cutting line
16 side seal portion boundary line
21 bottom seal portion
21a lower end seal
21b bottom shape-forming seal
21ba diagonal seal
21bb arc-shaped seal
21C conventional bottom seal portion
22 side seal portion
23 special step seal portion
24a unsealed first step portion
24b unsealed second step portion
25 unsealed bottom portion
26 conventional unsealed bottom portion
31 first step portion
32 second step portion
TL two-layer portion
FL four-layer portion
41 bottom portion-forming sealing member
42 step portion notch
43 side notch
44 bottom shape-forming seal-forming portion
44a diagonal seal-forming portion
44b arc-shaped seal-forming portion
45 lower end seal-forming portion
d width dimension
51 conventional bottom portion-forming sealing member
52 conventional bottom portion notch

1. A method for producing a self-standing packaging bag that includes a pair of flat portions and a bottom portion folded in half into an inverted V shape and disposed in a lower part of the pair of flat portions, that has side seal portions and bottom seal portions, and that has step portions formed due to overlapping of films between two-layer portions in which the pair of flat portions overlap each other and four-layer portions in which the pair of flat portions overlap the bottom portion,
the method comprising: in a first sealing step, performing heating and pressurization such that regions including at least parts of the step portions remain as unsealed portions and then performing cooling to form the bottom seal portions; and sealing the unsealed portions by heating, pressurization, and cooling in second and subsequent sealing steps.

2. The method for producing a self-standing packaging bag according to claim 1, wherein the pair of flat portions and the bottom portion are each formed of a film including a heat-sealable layer containing a polyester-based resin.

3. A sealing member used for a method for producing a self-standing packaging bag that includes a pair of flat portions and a bottom portion folded in half into an inverted V shape and disposed in a lower part of the pair of flat portions, that has side seal portions and bottom seal portions, and that has step portions formed due to overlapping of films between two-layer portions in which the pair of flat portions overlap each other and four-layer portions in which the pair of flat portions overlap the bottom portion,
wherein the sealing member is a heat sealing die used in a first sealing step to form the bottom seal portions such that regions including at least parts of the step portions remain as unsealed portions.

4. A self-standing packaging bag produced by the method for producing a self-standing packaging bag according to claim 1.

5. A self-standing packaging bag produced by the method for producing a self-standing packaging bag according to claim 2.

6. A method for producing a self-standing packaging bag that includes a pair of flat portions and a bottom portion folded in half into an inverted V shape and disposed in a lower part of the pair of flat portions, that has side seal portions and bottom seal portions, and that has step portions formed due to overlapping of films between two-layer portions in which the pair of flat portions overlap each other and four-layer portions in which the pair of flat portions overlap the bottom portion,
wherein the method uses a bag making machine including a plurality of sets of sealing jigs that are used for heating and pressurization and then for cooling, and
wherein the step portions include regions that are sealed only by a last set of sealing jigs.
